(19) United States
(12) Patent Application Publication
(10) Pub. No.: US 2013/0030913 A1
(43) Pub. Date: Jan. 31, 2013

(54) Deriving Ads Ranking of Local Advertisers based on Distance and Aggregate User Activities

(71) Applicants: Guangyu Zhu, Sunnyvale, CA (US); Ping Wu, Saratoga, CA (US); Emil Gilliam, Mountain View, CA (US); Surojit Chatterjee, Fremont, CA (US)

(72) Inventors: Guangyu Zhu, Sunnyvale, CA (US); Ping Wu, Saratoga, CA (US); Emil Gilliam, Mountain View, CA (US); Surojit Chatterjee, Fremont, CA (US)

(21) Appl. No.: 13/194,786

(22) Filed: Jul. 29, 2011

(51) Int. Cl. G06Q 30/02

(52) U.S. Cl. 705/14.52

(57) ABSTRACT

A system and method are disclosed including determining structured information sources that a local business participates in based on a common set of features that identify the business, collecting user interaction information from the structured information sources, aggregating the collected user interaction information into a set of attributes that are common across the structured information sources, storing local business location and the aggregated user interaction information for the set of attributes into a local business database, receiving a request from a mobile device for an ad including a geographic location, determining a geographic region that contains the geographic location, retrieving a set of local businesses from the local business database having locations within the region, determining distance values between the geographic location and the business locations, retrieving a subset of attributes for the aggregate user interaction information from the database, constructing feature vectors including the distance values and values for the attributes, calculating scores corresponding to feature vectors, and providing an ad in response to the ad request.

### BACKGROUND OF THE INVENTION

1. Technical Field

The inventive field relates to a method and apparatus for local advertising on mobile devices.

2. Background

Advertisers make structured information available about local businesses in various online services and advertising networks. Structured information is also made available through direct links, such as by Near Field Communication (NFC). This structured information (business name, location of the business, business hours, business category, and phone number) allows a local business to be identified and associated in several different structured information sources. The local businesses that provide information in various online services and advertising networks may not be aware of the collective performance of their advertisement campaign. Businesses that provide this information may desire to provide their information to an audience for which the information would be most relevant, and would seek to get more foot traffic and increased revenue. Users walking or driving through a neighborhood or street having local businesses may be interested in obtaining more information about local businesses, or finding out if there are any specials, coupons or discounts being offered by nearby local businesses.

### SUMMARY OF THE INVENTION

An aspect of the invention is a system including one or more processors, a computer-readable medium coupled to the one or more processors having instructions stored thereon, the one or more processors being configured to execute the instructions to perform collecting user interaction information from structured information sources, aggregating the collected user interaction information into a set of attributes that are common across the structured information sources, storing the aggregate user interaction information for the set of attributes into a local business database, receiving an ad request from a mobile device, the ad request including a geographic location, retrieving a subset of attributes for the aggregate user interaction information from the local business database, creating a feature vector for each of a plurality of local businesses from the subset of aggregate data, and computing a score for the respective feature vectors, the plurality of local businesses being within a region of the location contained in the ad request, and selecting one or more ads based on the scores and providing the selected ads as a response to the ad request.

A further aspect is a method performed on one or more server computers, including determining one or more structured information sources that a local business participates in based on a common set of features that identify the business, collecting user interaction information from the structured information sources, aggregating the collected user interaction information into a set of attributes that are common across the structured information sources, storing local business location and the aggregated user interaction information for the set of attributes into a local business database, receiving a request from a mobile device for an ad including a geographic location, determining a geographic region that contains the geographic location, retrieving a set of local businesses from the local business database having locations within the region, determining distance values between the geographic location and the business locations, retrieving a subset of attributes for the aggregate user interaction information from the local business database, constructing feature vectors including the distance values and values for the subset of the attributes, applying the feature vectors to a scoring component to calculate scores corresponding to feature vectors, and providing an ad to the mobile device corresponding to the feature vector having the highest score in response to the ad request.

### BRIEF DESCRIPTION OF THE DRAWINGS

FIG. 1 is a schematic block diagram for a system that aggregates and indexes user activities for local businesses and ranks local business ads;

FIG. 2 is a table of attributes and value type for aggregated data;

FIG. 3 is a flowchart for an example data aggregation process;

FIG. 4 is a flowchart for an example process for scoring local advertisers;

FIG. 5 is a block diagram for the training function of a machine learning model;

FIG. 6 is a table of values for logged items for logged data;

FIG. 7 is an example computer for performing the example processes; and

FIG. 8 illustrates an example Places Page with structured information.

### DETAILED DESCRIPTION OF THE INVENTION

A local business is one that has one or more physical locations (identified by an address). Local businesses may participate in online services, advertising networks, or direct links by way of technology such as Near Field Communication (NFC), which herein are referred to as structured information sources, as a way of advertising their products and/or services. Online services, advertising networks and direct links typically obtain a set of information in a structured format about a business. The information that can be obtained in the structured format may be business hours, a business category or categories, and a phone number or numbers. Through participation in online services, advertising networks, or direct links, a local business will submit their information in a structured format.

It is possible to identify local businesses by a set of information in the structured format that is common across the different online services and advertising networks that a business participates in, and obtain information about a local business that uses direct links. In particular, a set of attributes can be defined for common structured information of local businesses that enables identification of the particular local business in the various structured information sources that the business participates. Attributes that can be used to identify local businesses across such structured information sources can include business name, geographic location, business hours, a business category, and phone number.

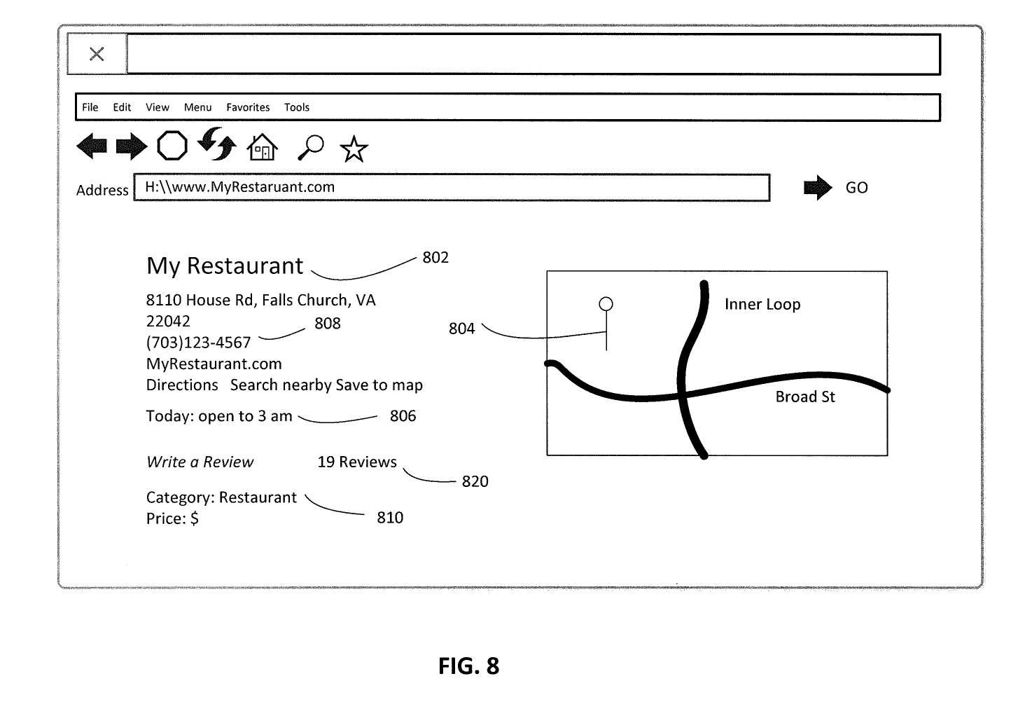

An example of a structured information source includes a Places page that a business participates. FIG. 8 illustrates an example Places page. The Places page may contain structured information including the business name 802, geographic location of the business 804, business hours 806, and phone number 808, and may show the business within one or more business categories 810. Other advertising networks may also include structured information providing the same business name, geographic location of the business, business hours, and phone number.

Provided identification for businesses across several of the structured information sources that they participate in, other information about a business can be collected from the structured information sources. For example, information from reviews and ratings 820 of the businesses can be obtained from the various structured information sources. Also, information about user interactions with a local business across the different structured information sources can be collected for the business. Information about user interactions can be obtained through, for example, the direct links to the local businesses. Check-ins are an example of user interactions with a local businesses that can use direct links.

In the case of check-ins, the user interactions can be by way of mobile applications or Web sites while the user is physically near the place of the local business. Information of the user interactions collected through the mobile application or Web site can include a quantity of check-ins for the local business.

In the case of other types of user interactions, information of the user interactions associated with a local business can include page visit count, user dwell time, and whether a map has been accessed, or whether an offer has been accessed and redeemed. Also, such actions as whether a phone number associated with a structured information source has been called, whether a user expanded a map associated with a structured information source, the length of time a map associated with the structured information source had remained opened, and the time of day that a structured information source was visited, can all be obtained from user interactions.

The totality of the information collected for a local business across different structured information sources can be aggregated. Aggregated data is an entire collection of data that is accessible for the local businesses, and the data can be either in structured or un-structured form. Aggregated data can also be accessed from logs of user activities and interactions. As will be discussed later, attributes for training and prediction are computed from the aggregated data.

Aggregated data for the local businesses can help businesses explore ways of improving their advertisement campaign. Also, ads for local businesses placed in various structured information sources can be evaluated in order to reach a local audience that is interested in information for that local business.

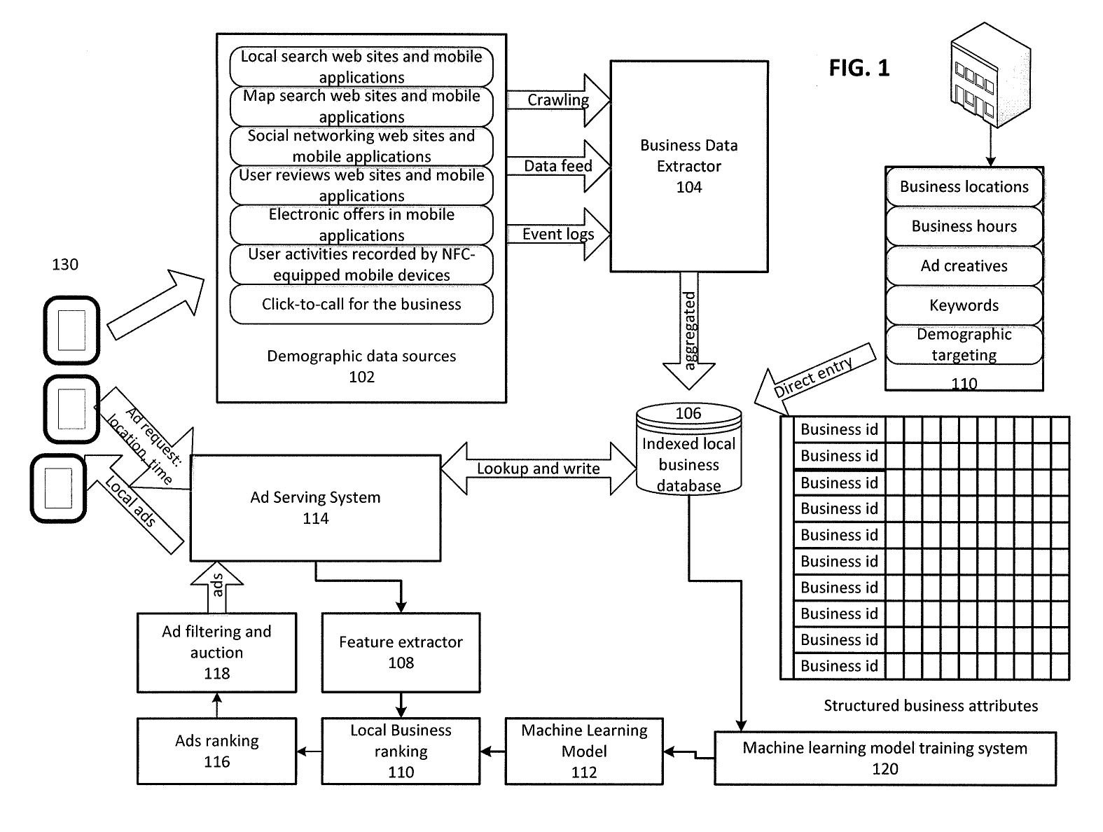

FIG. 1 is a schematic block diagram for system that aggregates and indexes user activities for local businesses, and ranks local business ads using models incorporating information computed from aggregate user activities. The system includes one or more computers that can communicate over wired or wireless networks. Various types of mobile applications or web sites enable local businesses to gain exposure and obtain feedback. The types of mobile applications and methods of communication are ever increasing. Using the mobile applications or web sites, mobile devices enable users to access various structured information sources. Types of structured information sources that may be interacted with by users and where a business may participate to gain exposure include local search web sites and related mobile applications, map search web sites and associated applications, social networking web sites and associated mobile applications, user reviews web sites and associated mobile applications, electronic offers in mobile applications, user activities while a user is physically near a local business using Near Field Communication (NFC) equipped devices, as well as click-to-call actions for businesses. As businesses obtain exposure through these various structured information sources, feedback data can be obtained across the structured information sources.

Once local businesses are identified in various structured data sources, the structured data sources become sources of information about the local businesses. In FIG. 1, data sources 102 represents the various structured information sources from which data can be extracted for local businesses. Data from the structured information sources can be extracted using crawling services, from direct data feed, or from event logs. A business data extractor 104 extracts data of local businesses obtained from the structured information sources by the crawling services, direct feed, or event logs. The extracted data can be in the form of attribute-value pairs. The business data extractor 104 can also obtain unstructured data about a local business.

Data can be collected from several of the structured information sources. Alternatively, data can be collected as new structured data sources are discovered to be associated with a local business. Business data extractor 104 aggregates the collected data into a set of structured business attributes. The set of structured business attributes for the collected aggregated data can be a set of attributes that are common across structured information sources.

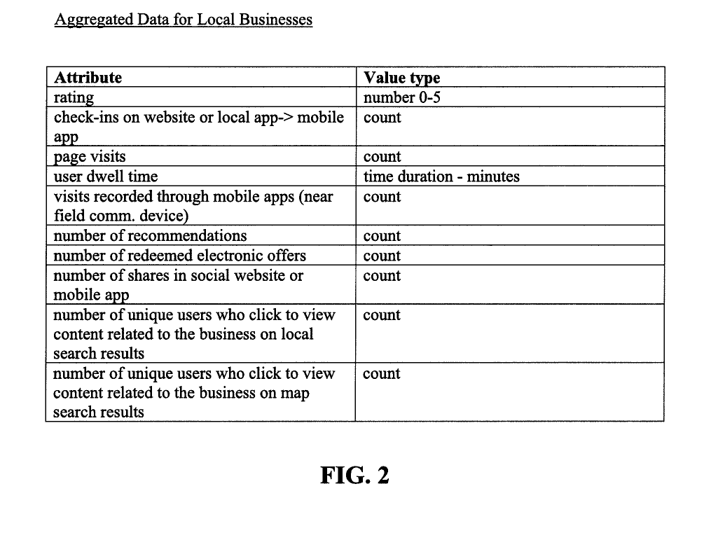

FIG. 2 is an example of a set of attributes and value types for aggregated data for local businesses. The attribute “rating”, for example, can take on a value from 0 to 5. Attributes, such as number of check-ins on a website, number of page visits, number of visits recorded through mobile apps, number of recommendations, number of redeemed electronic offers, number of shares in social website or mobile app, number of unique users who click to view content related to the business on local search results, and number of unique users who click to view content related to the business on map search results, can be obtained as count values. In addition, a user dwell time can be obtained for each page visit.

The aggregated data can be anonymized to protect individual users, through, for example, removal of personally identifying information, demographic aggregation of data, anonymization of user identifiers and/or device identifiers.

The aggregated data is maintained in a database of local business data 106, indexed by location. The database can be a flat file maintained in a single computer, or can be a large database system maintained in a network of computers, provided as a database back-end.

Local businesses can provide ads via a local business ad creative development client 110. The local business ad creative development client 110 provides a user interface for businesses to develop and submit ad creatives, along with other information useful for electronic access to information about the business. A local business can submit its business location, such as physical address, business hours, one or more ad creatives, keywords associated with products or services offered by the business, and any demographic targeting for the ad creatives.

An ad serving system 114 can receive a request for an ad from, for example, a mobile device 130. The request is in the form of a message that includes at least instructions for obtaining an ad in accordance with criteria, such as dimensions, size, device type, and a geographic location and time information of the request. The geographic location and time information can be the physical location and time of the mobile device 130 at the time of the request. Alternatively, the geographic location and time associated with an ad request can be a future location and time based on information entered by a user into a mobile application (mobile app). In an example embodiment, a user may be planning a trip by way of a travel planning mobile app. In such case, a user may enter a desired location and date, or dates, of travel. In another example embodiment, a user may enter a place of interest into a mobile app. The mobile device may determine a geographic location associated with the place of interest, and send a request for an ad that includes the geographic location, and can send a default time of the time that the request was sent.

There are various types of mobile devices, which are capable of being carried by a user to any location that a wireless signal can be transmitted, and being capable of communications by way of the wireless signal. Examples of mobile devices can include Smartphones having a voice communications chip that includes a capability of data communications and a central processing unit, tablet computer similar in construction to a Smartphone and having a larger display screen than a Smartphone, and a media player device similar in construction to a Smartphone but lacking a communications chip for voice communications. In each case, the mobile device at a minimum should enable interaction with a user. Interaction generally includes interaction with a touch-screen display device, such as a multi-touch display screen, but can include other forms of user manipulation. Also, a mobile device can include a Global Positioning System (GPS) for determining a physical location of the mobile device in terms of latitude and longitude.

The ad serving system 114 operates to provide one or more local ads in response to the request from the mobile device 130. The ad serving system itself can be a system of computers that collectively perform functions related to responding to requests for ads. The ad serving system 114 can be a Web application or a server process. The ad serving system 114 determines a neighborhood, street or region associated with the particular geographic location extracted from the request. A particular geographic location is typically the longitude and latitude for a device location, but can be a name of a geographic location. A map database system can be accessed by the ad serving system 114 in order to determine a region associated with a geographic location. The ad serving system 114 sends a retrieval request to the database of local businesses 106 to retrieve aggregated data of local businesses that are within the neighborhood or region of the geographic location.

A feature extractor component 108 can obtain the aggregated data of local businesses obtained from the database of local businesses 106 and create a feature vector for each retrieved local business. The feature extractor component 108 can be part of the ad serving system 114, or can be operated on its own dedicated computer or computer system. The feature extractor component 108 is capable of determining a distance between the geographic location received with the ad request and the location of a local business. The created feature vector will include the distance value, as well as attribute values from aggregated data for the local business.

The feature extractor component 108 can send a set of feature vectors to a machine learning model 112 or other evaluation system. Examples of other evaluation systems include random number generator, a polynomial having predetermined weight values, or a value of an attribute, such as rating. The machine learning model 112 takes as input a feature vector for a local business and produces a score associated with the feature vector. A local business ranking component 110 receives scores for each feature vector associated with the local businesses, sorts the local businesses by score, and may consider other evaluation criteria, such as keywords, in ranking the local businesses. Ads associated with corresponding evaluated local businesses are retrieved from local business database 106. An ad's ranking component 116 provides a ranked list of local ads based on results of evaluation of local businesses. An ad filtering and auction component 118 selects one or more ads to be sent as a response to the ad request. The local business ranking component 110, ads ranking component 116 and ad filtering and auction component 118 can be part of the ad serving system 114, or operate on their own dedicated computer or computers.

As will be described in more detail below, the machine learning model 112 can be trained by a training system 120 using data retrieved from the index of local businesses 106. The machine learning model 112 and associated training system 120 may be part of the ad serving system 114, or may be a separate computer or computer system. In some embodiments, the machine learning model 112 is one or more special purpose computers. Also, although FIG. 1 shows one machine learning model, there may be more than one machine learning model and more than one associated training system.

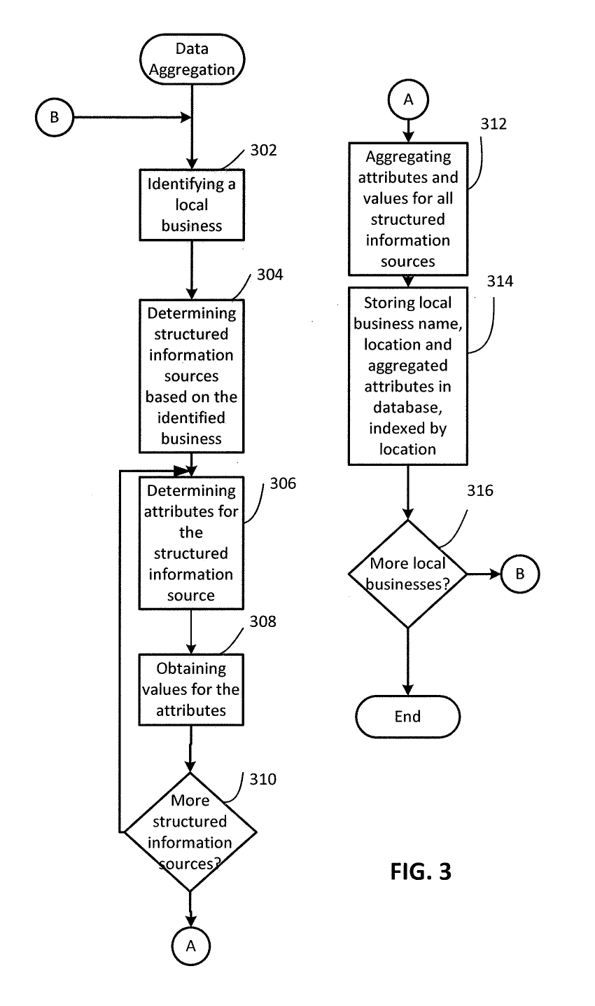

FIG. 3 is a flowchart for an example process performed by business data extractor 104. At step 302, a local business is identified by business name, geographic location, business hours, business category, and/or phone number. Other characteristics may be used to identify a local business depending on which attributes structured information sources use to identify a business. A common set of attributes across structured information sources of interest are selected as attributes for identifying a local business across structured information sources.

At step 304, the structured information sources that a business has registered with are determined. At step 306, the set of attributes that a structured information source uses are determined. At step 308, values are obtained for the attributes. According to step 310, steps 306 and 308 are performed for each structured information source until attributes and associated values are obtained for each structured information source for an associated business.

At step 312, the collected attributes and values for the structured information sources are aggregated. The step of aggregating 312 involves determining common attributes among structured information sources and consolidating values for the common attributes. An example set of attributes for aggregated data is shown in FIG. 2. As an example, ratings obtained from several structured information sources can be combined by calculating an average rating across all structured information sources that have a rating attribute.

At step 314, the aggregated attributes are stored in a database indexed by geographic location of the business. According to step 316, steps 302 to 314 are repeated for other local businesses in order to create the database of indexed local businesses.

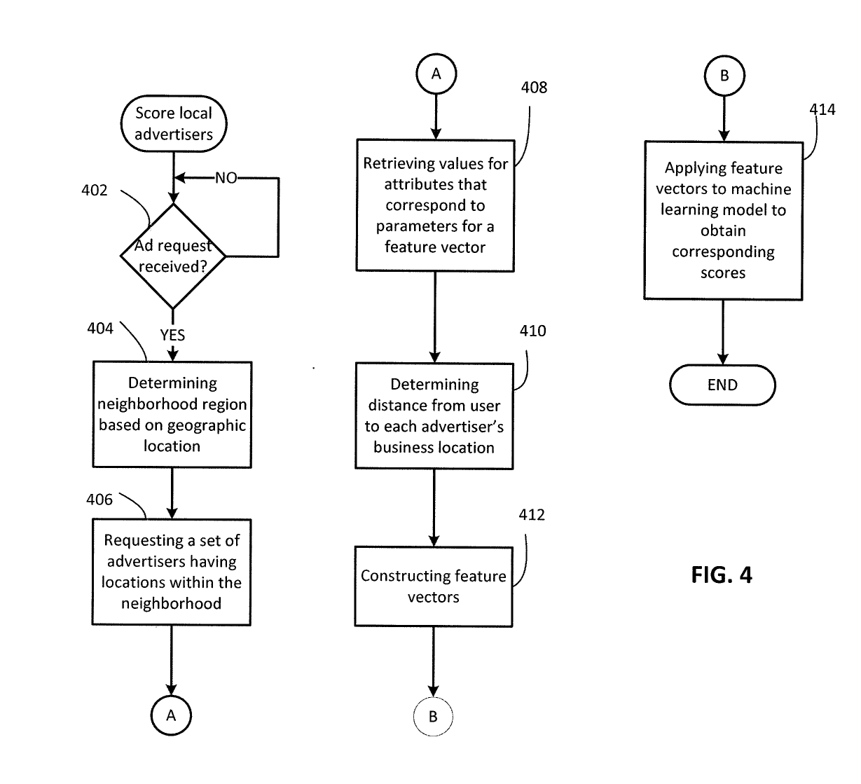

FIG. 4 is a flowchart for an example process that uses the database of indexed local businesses 104 to handle an ad request received from a mobile device 130. At step 402, the ad serving system 114 listens for an ad request. An ad request can include a geographic location of the mobile device 130 that sent the request. A geographic location of a mobile device 130 is typically in the form of a longitude and latitude. As mentioned above, a geographic location included with an ad request can be a location entered by a user of the mobile device 130 while using a mobile app. In addition, a geographic location included with an ad request can be obtained based on a place of interest that has been indicated by a user of the mobile device. In the case of a location entered by a user or a location obtained from a place of interest, a geographic location would be a name of a location. Upon receiving an ad request, at step 404, ad serving system 114 determines a neighborhood region based on the location received along with the ad request. The neighborhood region can be obtained using a mapping database, and can include a name of a neighborhood or street name.

The ad serving system 114, at step 406, requests a set of local businesses having locations corresponding to the neighborhood region. The set of local businesses is retrieved from the database of indexed local businesses 106. For each of the set of local businesses, values of attributes that correspond to parameters for a feature vector are retrieved at step 408. Attributes that have values used in the feature vector include the distance between the geographic location received from the mobile device, together with the ad request, and the geographic location of the local business. The distance value is determined at step 410. The values in the feature vector can include selected attributes from the indexed local businesses 106. Feature vectors are constructed at step 412.

At step 414, the feature vectors are applied to machine learning model 112 to obtain scores for each local business that was retrieved from the indexed local businesses 106. Local businesses can be ranked by the resulting scores by local business ranking component 110, and used to obtain an ad or ads for one or more of the ranked local businesses, where the obtained ad or ads is sent to the mobile device 130 as a response to the ad request.

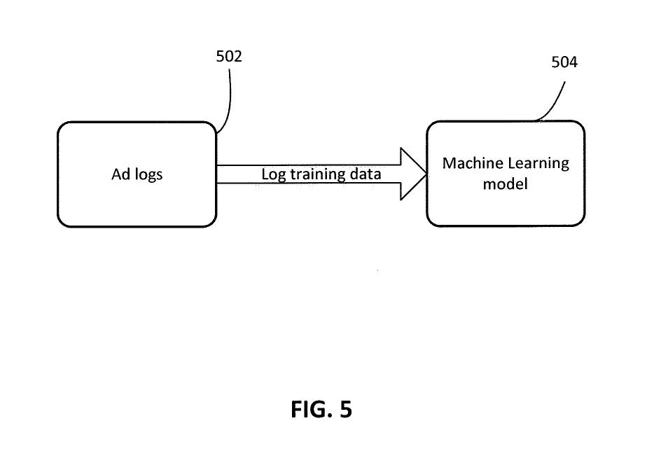

FIG. 5 is a block diagram for a function of training the machine learning model 112 using training system 120. A machine learning model can be performed on one or more general purpose computers using a machine learning program selected from among supervised learning-type machine learning techniques. Examples of supervised machine learning techniques are logistic regression or boosting, or a combination thereof. A machine learning model can be performed by a parallel processing computer consisting of several hundred interconnected microprocessors, or analog computing devices. The machine learning model can be performed by a computing device capable of parallel processing. The machine learning model 504 can be trained using data that is logged for ads 502, or data that is computed from logs stored in a log storage file or database.

Logistic regression is a statistics-based machine learning technique. Logistic regression uses a logistic function. The logistic function is based on a variable, referred to as a logit. The logit is defined in terms of a set of regression coefficients of corresponding independent predictor variables. Logistic regression can be used to predict the probability of occurrence of an event given a set of predictor variables.

A machine learning model using logistic regression may be as follows:

z=β₀+β₁x₁+β₁x₂+βₑx₃+ . . . +βₙxₙ

where β₁, β₂, and β₃ are regression coefficients for the respective predictor variables x₁, x₂, and x₃. The regression coefficients may be estimated using maximum likelihood or learned through a supervised learning technique from data collected in logs or calculated from log data. The predictor variables x of the machine learning model are the attributes that represent a feature vector for a local business. Provided a feature vector for a local business, a value for z can be calculated, and used to determine a probability, as

$$\frac{1}{1 + {e}^{- z}}$$

The probability can be used as a score for ranking and filtering local businesses and their respective ads.

Boosting is a machine learning technique in which a set of machine learning models are integrated to form a meta machine learning model. Typically, the set of machine learning models are first trained, then added to for a meta machine learning model that is further trained.

Boosting in combination with logistic regression can be performed by creating several logistic models for the same set of predictor variables, and adding the logistic models together.

Linear regression can be implemented using a linear neural network, for example, a network of a single layer. Boosting can be accomplished by training a set of linear neural networks over the same feature vector attributes, and adding the linear neural networks and training the weights of the added linear neural networks.

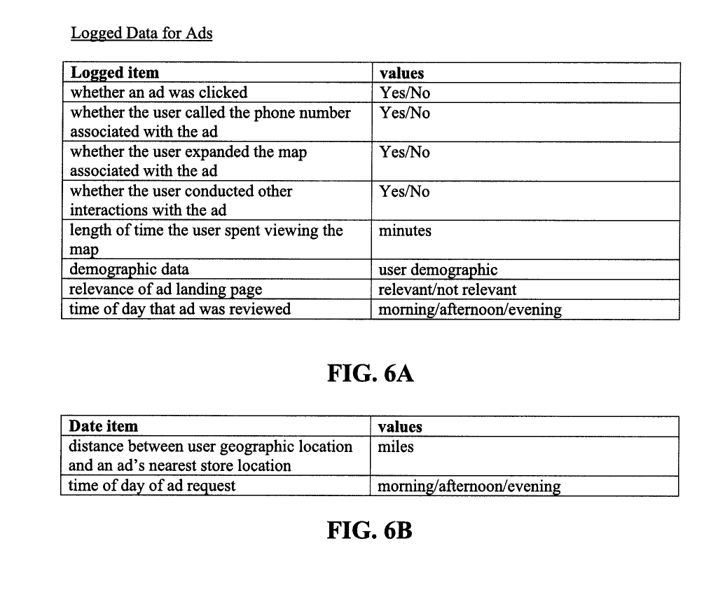

FIG. 6A is an example of types of information items that can be collected in logs or calculated from logged data. FIG. 6B is an example of additional data items that are used for training the machine learning model, as well as used as attributes of a feature vector for determining a probability. The logged data of FIG. 6A is derived from ads that have been presented to a user and interactions that the users have made with that ad, along with other information known about users, such as demographic data.

As with the aggregated data, the logged data can be anonymized to protect individual users, through, for example, removal of personally identifying information, demographic aggregation of data, anonymization of user identifiers and/or device identifiers.

In addition, a user of a mobile device 130 may be offered an opportunity to OPT-IN or OPT-OUT of having data collected based on their usage of the mobile device. An OPT-IN procedure would offer a user an opportunity to elect to enable data to be collected from their mobile device. An OPT-OUT procedure would ask a user if they do not want data collected from their mobile device.

Any of the aggregated data of FIG. 2, logged data of FIG. 6A, and data items of FIG. 6B can be used to construct a feature vector. The choice of aggregated data, logged data and data items depends on a prediction to be made. In the case of logistic regression, the prediction is a prediction of a probability of an occurrence of an event. The machine learning model, having been trained using a subset of aggregated data of FIG. 2, the log data of FIG. 6A and data items of FIG. 6B, computes a probability for the feature vector.

In an example embodiment, the machine learning model is one that has been trained to predict a probability (0% to 100%) that a given ad for a local business will be clicked, if presented to a user. Other types of user interactions with local ads (for example, probability of viewing a map) are possible. In an example embodiment, separate machine learning models can be constructed to predict the probabilities of each of the types of user interactions. In each case, the machine learning model has its own set of attributes as a feature vector.

The machine learning model can be incrementally trained. For example, a machine learning model can be trained by first training a model using all ads. The initial training may, for example, lead to a model that predicts that any ad has a 1% probability of being clicked. Over a period of several months, the model can be further trained by iterating through log data, which contains the features of every ad served during that period, along with a “label” (for example, whether an ad has been clicked or not). For each ad, the model predicts the probability of the ad being clicked, where each ad click (or non-click) adjusts the model by an increment.

An example of logged items of FIG. 6A as a feature vector can be trained. An example subset of aggregated data attributes, logged data attributes, and data item attributes for a feature vector is as follows.
Ad clicked: Yes
User called phone number: No
User expanded map: No
Length of time spent viewing the map: 0 seconds
Distance: 500 meters

The corresponding feature vector is x={1.0, −1.0, −1.0, 1.0, 500.0}, where 1.0 represents Boolean “Yes”, and −1.0 represents Boolean “No”.

A machine learning model can be used to compute a probability of a user action from the feature vector. In the example embodiment, applying the feature vector to the machine learning model produces a medium probability of a user interaction:

In the example embodiment, using the same values, but changing values for attributes “user expanded map” and “length of time spent viewing the map”, for example:
User expanded map: Yes
Length of time spent viewing the map: 10 seconds
   leads to a higher probability of user interaction.

In other words, in the example embodiment, the machine learning model gives more weight to time spent viewing a map, possibly because viewing a map is an indication that users are interested in the particular location of the local businesses.

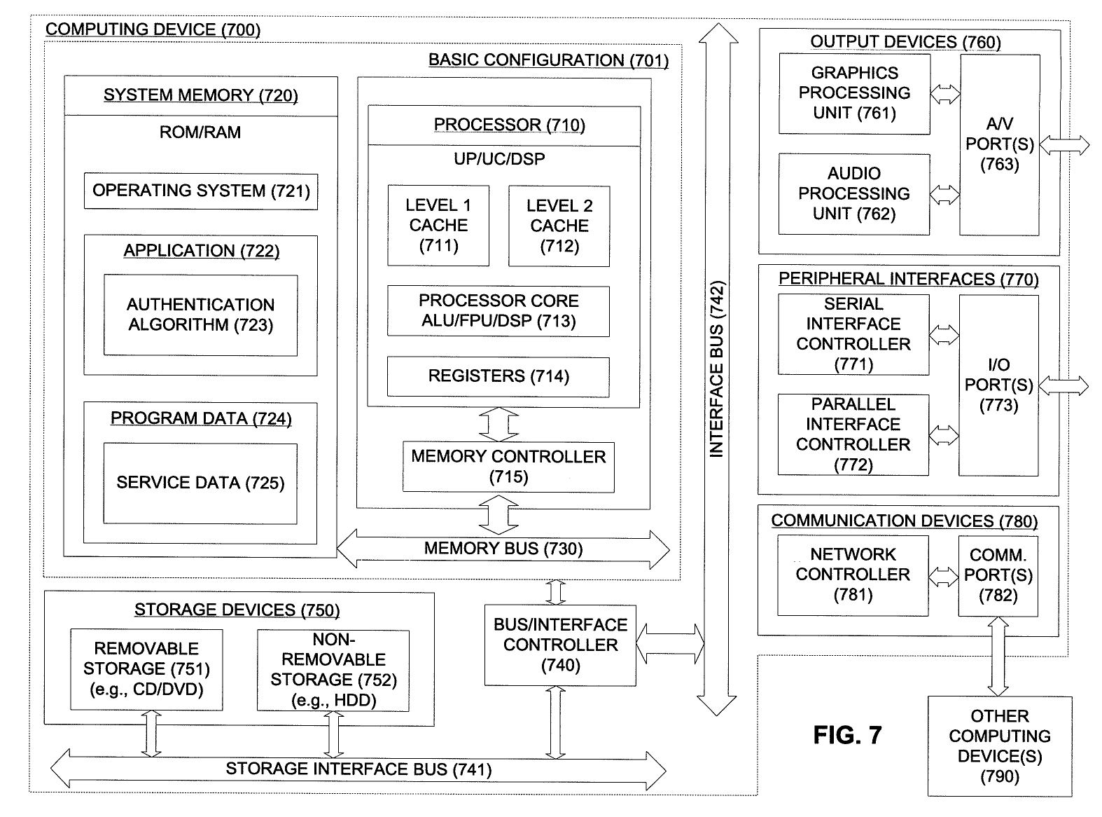

FIG. 7 is a block diagram illustrating an example computing device 700 that is arranged for ranking of local advertisers in accordance with the present disclosure. In a very basic configuration 701, computing device 700 typically includes one or more processors 710 and system memory 720. A memory bus 730 can be used for communicating between the processor 710 and the system memory 720.

Depending on the desired configuration, processor 710 can be of any type including but not limited to a microprocessor (μP), a microcontroller (μC), a digital signal processor (DSP), or any combination thereof. Processor 710 can include one more levels of caching, such as a level one cache 711 and a level two cache 712, a processor core 713, and registers 714. The processor core 713 can include an arithmetic logic unit (ALU), a floating point unit (FPU), a digital signal processing core (DSP Core), or any combination thereof. A memory controller 715 can also be used with the processor 710, or in some implementations the memory controller 715 can be an internal part of the processor 710.

Depending on the desired configuration, the system memory 720 can be of any type including but not limited to volatile memory (such as RAM), non-volatile memory (such as ROM, flash memory, etc.) or any combination thereof. System memory 720 typically includes an operating system 721, one or more applications 722, and program data 724.

Application 722 includes an ads processing algorithm 723 that is arranged to . . . Program Data 724 includes aggregated user activity data 725 that is useful for scoring local businesses, as will be further described below. In some embodiments, application 722 can be arranged to operate with program data 724 on an operating system 721. This described basic configuration is illustrated in FIG. 7 by those components within dashed line 701.

Computing device 700 can have additional features or functionality, and additional interfaces to facilitate communications between the basic configuration 701 and any required devices and interfaces. For example, a bus/interface controller 740 can be used to facilitate communications between the basic configuration 701 and one or more data storage devices 750 via a storage interface bus 741. The data storage devices 750 can be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 720, removable storage 751 and non-removable storage 752 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of device 700.

Computing device 700 can also include an interface bus 742 for facilitating communication from various interface devices (e.g., output interfaces, peripheral interfaces, and communication interfaces) to the basic configuration 701 via the bus/interface controller 740. Example output devices 760 include a graphics processing unit 761 and an audio processing unit 762, which can be configured to communicate to various external devices such as a display or speakers via one or more A/V ports 763. Example peripheral interfaces 770 include a serial interface controller 771 or a parallel interface controller 772, which can be configured to communicate with external devices such as input devices (e.g., keyboard, mouse, pen, voice input device, touch input device, etc.) or other peripheral devices (e.g., printer, scanner, etc.) via one or more I/O ports 773. An example communication device 780 includes a network controller 781, which can be arranged to facilitate communications with one or more other computing devices 790 over a network communication via one or more communication ports 782. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 700 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system comprising:
one or more processors;
a computer-readable medium coupled to the one or more processors having instructions stored thereon, the one or more processors being configured to execute the instructions to perform operations comprising:
collecting user interaction information from structured information sources;
aggregating the collected user interaction information into a set of attributes that are common across the structured information sources;
storing the aggregate user interaction information for the set of attributes into a local business database;
receiving an ad request from a mobile device, the ad request including a geographic location;
retrieving a subset of attributes for the aggregate user interaction information from the local business database;
creating a feature vector for each of a plurality of local businesses from the subset of attributes;
computing a score for the respective feature vectors, the plurality of local businesses being within a region of the location contained in the ad request; and
selecting one or more ads based on the scores and providing the selected ads as a response to the ad request.

2. The system of claim 1, wherein the received ad request includes a geographic location of the mobile device at the time the request was made.

3. The system of claim 1, wherein the received ad request includes a geographic location of interest specified by a mobile app.

4. The system of claim 1, wherein said structured information sources are structured information sources that the local businesses participate in, wherein the user interaction information collected from the structured information sources that the local businesses participate in is stored in the local business database.

5. The system of claim 4, wherein said structured information sources further comprise a log of user interaction information for the local businesses, wherein the user interaction information collected from the log of user interaction information is stored in the local business database.

6. The system of claim 1, wherein the scores are computed using a machine learning model.

7. The system of claim 6, wherein:
the machine learning model is trained by a supervised learning technique using aggregate user interaction information stored in the local business database.

8. The system of claim 1, further comprising ranking local businesses based on the scores, and selecting an ad for a local business from among ranked local businesses based on predetermined criteria.

9. The system of claim 5, wherein the user interaction information collected from the log of user interaction information includes one or more of whether an ad was clicked, whether the user called the phone number associated with the ad, whether the user expanded a map associated with a local ad, whether the user performed other interactions between the user and the ad, the length of time that a user spent viewing the map, the distance from a geographic location to an ad's nearest business location, the time of day that the ad was viewed, a demographic feature associated with the user's location, quality of an ad landing page.

10. The system of claim 7, wherein the machine learning model is a logistic regression model.

11. The system of claim 7, wherein the machine learning model is a plurality of machine learning models trained by boosting.

12. The system of claim 7, wherein the machine learning model is a plurality of logistic regression models trained by boosting.

13. The system of claim 4, wherein at least one structured information source that local businesses participates in is a Web site having a set of attributes for local businesses, that includes an attribute for a location address.

14. A method performed on one or more server computers, comprising:
determining one or more structured information sources that a local business participates in based on a common set of features that identify the business;
collecting user interaction information from the structured information sources;
aggregating the collected user interaction information into a set of attributes that are common across the structured information sources;
storing local business geographic location and the aggregated user interaction information for the set of attributes into a local business database;
receiving a request from a mobile device for an ad including a geographic location;
determining a geographic region that contains the geographic location;
retrieving a set of local businesses from the database of local businesses having locations within the geographic region;
determining distance values between the geographic location that the request originated from and the business locations;
retrieving a subset of attributes for the aggregate user interaction information from the local business database;
constructing feature vectors including the distance values and values for the subset of the attributes;
calculating scores corresponding to feature vectors; and
providing an ad to the mobile device corresponding to the feature vector having the highest score in response to the ad request.

15. The system of claim 14, wherein the received ad request includes a geographic location of the mobile device at the time the request was made.

16. The system of claim 14, wherein the received ad request includes a geographic location of interest specified by a mobile app.

17. The method of claim 14, wherein the attributes include one or more of whether an ad was clicked, whether the user called the phone number associated with the ad, whether the user expanded a map associated with a local ad, whether the user performed other interactions between the user and the ad, the length of time that a user spent viewing the map, the distance from a geographic location to an ad's nearest business location, the time of day that the ad was viewed, a demographic feature associated with the user's location, quality of an ad landing page.

18. The method of claim 17, wherein the step of applying the feature vectors to calculate scores includes determining a probability that an ad will be clicked.

19. The method of claim 17, wherein the step of applying the feature vectors to calculate scores includes determining a probability that a call will be made for a phone number associated with an ad.

20. The method of claim 17, wherein the step of applying the feature vectors to calculate scores includes determining a probability an interaction will be made between a user and an ad.
